(19) United States
(12) Patent Application Publication
(10) Pub. No.: US 2004/0044750 A1
(43) Pub. Date: Mar. 4, 2004

(54) Method for transferring software to programmable components and placement system for placing components on substrates

(76) Inventors: Friedrich Eschenweck, Feldkirchen (DE); Werner Liegel, Geretsried (DE)

Correspondence Address: HARNESS, DICKEY & PIERCE, P.L.C., P.O.BOX 8910, RESTON, VA, 20195, US

(21) Appl. No.: 10/231,028

(22) Filed: Aug. 30, 2002

(51) Int. Cl. G06F 15/177

(52) U.S. Cl. 709/220

(57) ABSTRACT

Disclosed are a method for transferring software to programmable components and a placement system for placing components on substrates. The components are placed on substrates via a placement system with a plurality of processing units, which are connected with each other via an interface. The processing units can be controlled in order to place the components. Software that is to be transferred to the components may be transferred to the components via the interface and contact devices that are provided on the processing units.

### FIELD OF THE INVENTION

The invention generally relates to a method for transferring software to programmable components and a placement system for placing components on substrates with a multitude of processing units, in particular, placement devices and feed modules for feeding components.

### BACKGROUND OF THE INVENTION

Components, as they are used today in a multitude of electric devices, are programmable to an ever increasing extent in order to provide the user of the components with the largest possible design freedom with regard to the desired functional scope of the components. During production of the devices that are supposed to be installed in the components for example placement devices are used, which contain among other things processing units such as transport segments, placement devices and feed modules. The components in this example are placed onto substrates with the placement devices. The printed substrates are transported to other processing units, such as a soldering furnace or testing equipment, via conveying segments.

If programmable components are to be incorporated on a substrate, it is desirable that these programmable components can already be programmed during processing in the placement device. This offers the benefit that the finished printed substrates can be directly processed further without having to place the software, which is provided for the programmable components, in a separate step onto the programmable components. Conventionally the software for the programmable components is made available for example on the feed modules, which feed the components to the placement devices.

In this case for example memory cards are used, which are inserted in the feed modules. The memory cards store the software that has been specified for the programmable components. The feed modules can read the software from the memory cards and transfer it to the components.

This however has the disadvantage that it cannot be ensured whether the correct software is on the memory card and the memory card with the correct software was inserted into the correct feed module. Additionally, making the software available through memory cards makes interventions by the operator of the placement device necessary, which causes personnel needs to be very high.

### SUMMARY OF THE INVENTION

It is an object of an embodiment of the present invention to provide a method for transferring software to programmable components as well as a placement device for placing components on substrates where operating safety and reliability are improved and processing speed is increased.

The object is achieved in accordance with a method and the features pursuant to claim 1 as well as a placement system with the features pursuant to claim 9. Additional preferred embodiments of the invention are claimed in the dependent claims.

According to an embodiment of the present invention a method for transferring software to programmable components is created. Components are placed onto substrates with a placement system, which contains a plurality of processing units. The processing units of the placement system are connected with each other via an interface. It is via this interface that the processing units of the placement system for placing the components can be controlled.

Pursuant to an embodiment of the present invention, software is transferred to the programmable components via the interface, which connects the processing units with each other, as well as via contact devices, which are provided on the processing units. This offers the benefit that an intervention of the operator for allocation of the software to the programmable components is not required. The software can be transferred to the processing units, of which the components are programmable, directly via the interface, which connects the processing units with each other. This way additional data transmission, such as that via a memory card on which the software has been stored, can be eliminated. The programmable components are preferably also programmed in a contact-free manner by the contact devices.

The software can be transferred to the components both before placement as well as during or after placement. It is therefore possible to provide the contact device on the feed modules of a placement system, on the placement devices or as a separate unit. In case the contact devices are provided on the feed modules, the software is transferred to the components before placement. If the contact devices are provided on the placement devices, the software can be transferred to the components before placement, during placement or after placement.

The software can be issued by a control device to the interface. In this case, for example, the control device, which also controls the processing units via the interface, can serve as the control device. It is not required to provide additional control devices.

It is furthermore possible after placement to perform a test of the printed substrates and/or the components that have been equipped with the software, wherein said test is controlled via the interface. For this, depending on suitability, the contact device that is provided on the processing units can be used. However it is also possible to provide an additional second contact device, which can contact the printed substrates for performing the tests and can be connected with the interface. The second contact device as well can be suited for contact-free contacting of the programmable components and/or of the substrates. The test can be performed for example with the control device.

Pursuant to an embodiment of the present invention also a placement system for placing components on substrates with a plurality of processing units, which are connected via an interface, is created. The processing units of the placement system are in particular placement devices for placing the components as well as feed modules for feeding the components to the placement devices. On the feed modules and/or on the placement devices, contact devices are provided for contacting the components. The interface and the contact devices are designed for transmitting the software to the components.

An embodiment of the present invention thus makes it possible to transfer software to programmable components via said interface, which connects the processing units of a placement system with each other. This way, an external method for making the software, which is to be transferred to the programmable components, available—for example through memory cards or an external computer system, which can be connected with feed modules of the placement system—can thus be avoided.

The software that is to be transferred can be transferred to the programmable components for example via a control device that is coupled with the interface, wherein said control device also controls the processing devices. This way the software that is to be transmitted can be used and administered like an element of a control program from the placement system.

The finished printed substrates and/or the programmable components can be tested through the interface. Such tests can be performed for example by the control device. During the tests, the substrates can be coupled with the interface via the contact devices or via additional second contact devices. This case ensures that the substrates can be contacted without great effort, as a function of the type of test that is to be performed.

The interface can be for example a serial interface, a parallel interface or a computer network such as a telecommunications network, e.g. internet-based networks, or a local network, such as Ethernet.

This way a simple connection of the programmable components to the network that is already in existence in the placement system is ensured.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 as a diagrammatic view of a preferred embodiment of the invention.

### DETAILED DESCRIPTION OF THE PREFERRED EMBODIMENTS

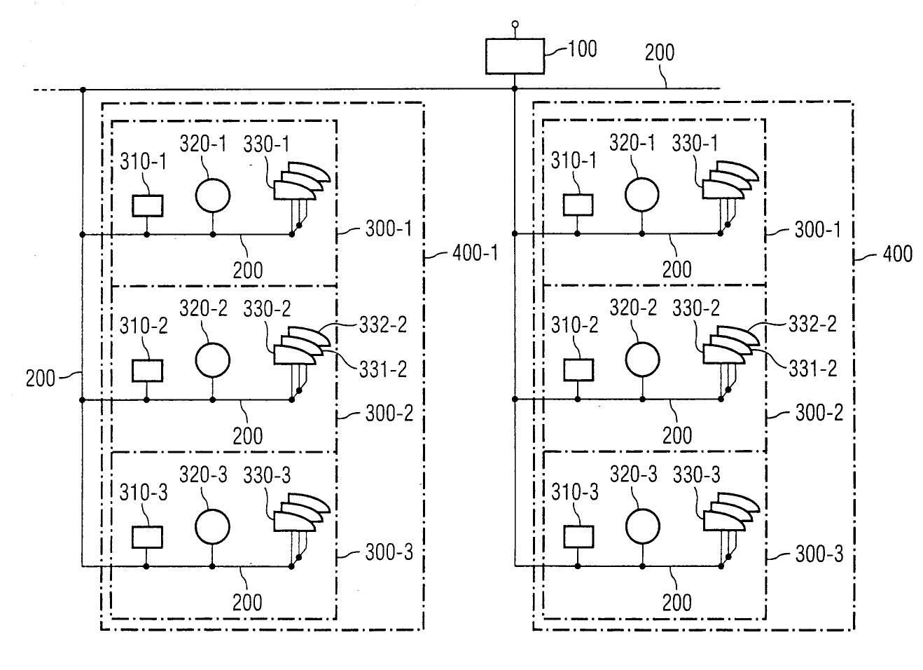

FIG. 1 shows a control device 100, which is connected with a plurality of placement lines 400, 400-1 via an interface 200. The control device 100 processes among other things a placement program, which contains control instructions for the placement lines 400, 400-1. Each placement line can include one or more placement systems 300-1, 300-2, 300-3. The control instructions are suitable for controlling the placement systems 300-1, 300-2 and 300-3.

The placement systems 300-1, 300-2 and 300-3 are likewise connected with the interface 200. The interface 200 serves the purpose of data exchange with the control device 100. An Ethernet computer network for example can be used as interface.

Each placement device 300-1, 300-2 and 300-3 contains for example a transport device 310-1, 310-2 or 310-3. The transport device can be used to feed substrates (not shown) that are to be printed to the placement devices 320-1, 320-2 or 320-3 of the respective placement system 300-1, 300-2 or 300-3. Each placement system 300-1, 300-2 and 300-3 contains one or more feed modules 330-1, 330-2, 332-2, 333-3.

The transport devices 310-1, 310-2, 310-3, the placement devices 320-1, 320-2, 320-3 and the feed modules 330-1, 330-2, 330-3 are also connected with the interface 200. The placement program, which is processed by the control device 100, issues e.g. control instructions for the placement devices 320-1, 320-2 and 320-3 of the placement systems 300-1, 300-2 or 300-3.

If programmable components (not shown) are supposed to be printed, then those software elements, which are to be transferred to the programmable components, can be integrated into that placement program, which is performed by the control device 100.

For this, the software elements are issued from the control device 100 to the interface 200. Via the interface 200 the software elements are transferred to the feed modules 330-1, 330-2, 330-3 of the placement robots 300-1, 330-2 or 300-3. In doing so, the software elements can be transferred selectively to the individual feed modules 330-1, 330-2, 330-3 in dependency of the type of the programmable component and the function of the programmable component, which it is supposed to fulfill on the printed substrate.

Initially it is being determined which component is fed by the respective feed module 330-1, 330-2 or 330-3 or is available there. Subsequently the control device 100 determines from the placement program which software element is provided for the determined programmable component that is fed by the respective feed module 330-1, 330-2 or 330-3. The appropriate software element can be transferred via the interface 200 to that feed module 330-1, 330-2 or 330-3, on which the programmable component that is available there is supposed to be equipped with said software element.

In order to be able to transfer the software element to the programmable component, the feed modules 330-1, 330-2 and 330-3 can be equipped with contact devices (not shown), from which those contact surface or contact areas of the programmable components can be contacted, which are required for programming the respective components. It is also possible to use contact devices that operate contact-free. With these, programming can be performed e.g. via infrared radiation or radio-frequency radiation.

It is also possible to perform a test of the finished printed substrates and/or the programmable components via the contact devices that are provided on the feed modules or via additional second contact devices. Therefore, the test can be controlled via the interface 200 by the control device 100. It is possible e.g. to check whether the software elements that were transferred to the programmable components were transferred correctly, whether the components were placed correctly on the substrate, and/or whether the printed substrate exhibits the desired functions. Also the second contact devices can be designed as contact devices that operate contact-free, similar to the above-described contact devices.

Pursuant to an embodiment of the present invention, a transfer of the software, the test of the substrates and/or the functional test of the programmable components that have been equipped with the software can be performed contact-free. This is suited for example for contact-free programmable components and/or contact-free operating interfaces on the substrates. The contact devices required for this operate also contact-free, e.g. through radio-frequency or infrared or by employing transponder technology.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for transferring software to programmable components, comprising:
placing components on substrates by way of a placement system having a plurality of processing units, the plurality of processing units being connected together by way of an interface, wherein the plurality of processing units are controllable for the placing of the components, and
transferring the software to the components by way of the interface and contact devices being provided on the processing units.

2. A method according to claim 1, wherein the software is transferred to the components before placement thereof.

3. A method according to claim 1, wherein the software is transferred to the components one of during and after placement.

4. A method according to claim 1, further comprising transferring the software to the interface by way of the control device.

5. A method according to claim 1, further comprising controlling the processing units by way of the control device and via the interface.

6. A method in accordance to claim 1, further comprising testing the substrates having components placed thereon, the test being controlled via the interface.

7. The method according to claim 6, wherein, at least during the testing, the substrates are connected with the interface by way of the contact devices or by way of additional contact devices.

8. The method according to claim 6, wherein the test is performed through by way of control device.

9. The method according to claim 1, further comprising performing a functional test after the transfer of software to components, the functional test being used to check functionality of the programmed components.

10. The method according to claim 9, wherein the functional test is performed through the control device by way of the contact devices.

11. The method according to claim 1, wherein the transferring of software is performed contact-free by way of the contact devices.

12. A placement system for placing components on substrates with a plurality of processing units, comprising:
placement devices being connected by way of an interface, the placement devices being functional for placing components on substrates; and
feed modules for feeding the components to the placement devices,
wherein the feed modules include contact devices for communicating with the components, and the interface and the contact devices are operable to transfer software to the components.

13. The placement system according to claim 12, wherein the software is transferable to the components through a control device being coupled with the interface.

14. The placement system according to claim 13, wherein the substrates and the components are checkable by the control device during a test that is performed by way of the interface.

15. The placement system according to claim 14, wherein the substrates are coupled with the interface at least during the test by way of one of the contact devices and additional contact devices.

16. The placement system according to claim 12, wherein the processing units are controllable by the control device by way of the interface.

17. The placement system according to claim 12, wherein the interface is a computer network.

18. A method according to claim 2, further comprising transferring the software to the interface by way of a control device.

19. A method according to claim 3, further comprising transferring the software to the interface by way of a control device.

20. The method according to claim 7, wherein the test is performed through by way of control device.

21. The method according to claim 6, wherein the test is performed contact-free by way of the contact devices.

22. The method according to claim 9, wherein the functional test is performed contact-free by way of the contact devices.

23. The method according to claim 12, wherein the placement devices include contact devices for communicating with the components.

24. The placement system according to claim 13, wherein the processing units are controllable by the control device by way of the interface.

25. The placement system according to claim 14, wherein the processing units are controllable by the control device by way of the interface.

26. The placement system according to claim 15, wherein the processing units are controllable by the control device by way of the interface.
